(19) United States
(12) Patent Application Publication
(10) Pub. No.: US 2015/0371109 A1
(43) Pub. Date: Dec. 24, 2015

(54) AUTOMATED VEHICLE RECOGNITION

(71) Applicant: SENSEN NETWORKS PTY LTD, Bulleen, Victoria (AU)

(72) Inventors: Nhat Dinh Minh Vo, Victoria (AU); Subhash Challa, Victoria (AU)

(21) Appl. No.: 14/761,937

(22) PCT Filed: Jan. 17, 2014
(86) PCT No.: PCT/AU2014/000029

§ 371 Date: Jul. 17, 2015

(30) Foreign Application Priority Data
Jan. 17, 2013 (AU) 2013900153

(51) Int. Cl. G06K 9/62; G06T 7/20; G06K 9/52; G06T 7/00; G06K 9/32; G06K 9/46

(52) U.S. Cl. CPC G06K 9/6201; G06K 9/325; G06K 9/46; G06K 9/52; G06T 7/0044; G06T 7/20; G06K 2009/4666; G06K 2009/6213

(57) ABSTRACT

A system for identifying a vehicle. A camera obtains at least one image of a vehicle. An image processor derives from the image a first sub-image and a second sub-image distinct from the first sub-image, extracts from the first sub-image a first set of image features, and extracts from the second sub-image a second set of image features. The image processor matches the first set of image features to corresponding image features derived from a previously obtained image of a vehicle to produce a first matching score, and also matches the second set of image features to corresponding image features derived from a previously obtained image of a vehicle to produce a second matching score. The image processor then fuses the first matching score and the second matching score to produce a fused score which indicates whether the at least one image is of the same vehicle as the previously obtained image.

### CROSS-REFERENCE TO RELATED APPLICATIONS

This application claims the benefit of Australian Provisional Patent Application No. 2013900153 filed 17 Jan. 2013, which is incorporated herein by reference.

### TECHNICAL FIELD

The present invention relates to recognising vehicles, and in particular to a system and method configured to recognise a vehicle based on visible features of the vehicle including the registration plate and also including other visible features of the vehicle.

### BACKGROUND OF THE INVENTION

A range of circumstances can arise in which it is desirable to identify a vehicle in an automated manner. One application of automated vehicle identification is in relation to electronic toll collection. Electronic toll collection is typically effected by equipping a user's vehicle with an electronic transponder. When the vehicle and transponder pass through a toll plaza, the transponder communicates with the toll booth and the applicable toll is deducted from the user's account. A camera is usually provided if a vehicle passes through without a transponder, so that an off-line payment or penalty fine can subsequently be obtained from the driver by tracking the vehicle registration plate.

However, some electronic tolling systems are vulnerable to fraud whereby a transponder or vehicle pass purchased for a small vehicle at a low tolling rate may be affixed to a large vehicle to which a higher toll rate should apply. While inductive sensors, treadles and/or light-curtain lasers may be deployed in an attempt to identify or at least categorise a vehicle, this involves considerable additional hardware expense at each toll booth.

Vehicle identification can also be desirable in other applications such as street parking enforcement, parking centre enforcement, vehicle speed enforcement, point-to-point vehicle travel time measurements, and the like.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In this specification, a statement that an element may be “at least one of” a list of options is to be understood that the element may be any one of the listed options, or may be any combination of two or more of the listed options.

### SUMMARY OF THE INVENTION

According to a first aspect the present invention provides a method of identifying a vehicle, the method comprising:

obtaining from at least one camera at least one image of a vehicle;

using an image processor to derive from the at least one image a first sub-image and a second sub-image distinct from the first sub-image;

extracting from the first sub-image a first set of image features;

extracting from the second sub-image a second set of image features;

matching the first set of image features to corresponding image features derived from a previously obtained image of a vehicle to produce a first matching score;

matching the second set of image features to corresponding image features derived from a previously obtained image of a vehicle to produce a second matching score; and

fusing the first matching score and the second matching score to produce a fused score which indicates whether the at least one image is of the same vehicle as the previously obtained image.

According to a second aspect the present invention provides a system for identifying a vehicle, the system comprising:

at least one camera for obtaining at least one image of a vehicle; and

an image processor for
deriving from the at least one image a first sub-image and a second sub-image distinct from the first sub-image;
extracting from the first sub-image a first set of image features;
extracting from the second sub-image a second set of image features;
matching the first set of image features to corresponding image features derived from a previously obtained image of a vehicle to produce a first matching score;
matching the second set of image features to corresponding image features derived from a previously obtained image of a vehicle to produce a second matching score; and
fusing the first matching score and the second matching score to produce a fused score which indicates whether the at least one image is of the same vehicle as the previously obtained image.

According to a further aspect the present invention provides a computing device configured to carry out the method of the first aspect.

According to another aspect the present invention provides a computer program product comprising computer program code means to make a computer execute a procedure for identifying a vehicle, the computer program product comprising computer program code means for carrying out the method of the first aspect.

The first and second sub-images preferably comprise two of: a vehicle license plate sub-image, a vehicle logo sub-image, and a vehicle region of interest sub-image. In some embodiments all three such sub-images may be extracted, matched and score fused. The sub-images preferably consist of wholly distinct sub-areas of the at least one obtained image. The region of interest may comprise one or more of: a vehicle fender, for example to match bumper stickers; or a particular vehicle panel, for example to match stained or dirty portions of the vehicle, a colour of the vehicle or damage to the vehicle. However in some embodiments first and second sub-images may overlap partly or completely, and may for example both be images of a license plate of the vehicle.

In preferred embodiments, each set of image features comprises image features which are tolerant to image translation, scaling, and rotation, as may occur between images of the same vehicle taken at different times and/or in different locations. Additionally or alternatively, each set of image features preferably comprises image features which are tolerant to changes in illumination and/or low bit-rate storage for fast matching.

In some embodiments, extracting the first and/or second set of image features may comprise a first step of coarse localisation of feature key points in the respective sub-image. Localised feature key points preferably have a well-defined position in image space and have a local image structure which is rich in local information. For example, feature key points may be localised by a corner detection technique, or more preferably by combined used of multiple corner detection techniques.

Preferably, the first and/or second set of image features are vetted in order to eliminate unqualified feature points.

In embodiments in which feature key points are localised, one or more robust descriptors of each key point are preferably obtained. The descriptors are preferably robust in the sense of being somewhat invariant to changes in scaling, rotation, illumination and the like.

In preferred embodiments, matching the first set of image features to corresponding image features derived from a previously obtained image of a vehicle to produce a first matching score may comprise applying distance matching and voting techniques in order to determine the match between the descriptors of one feature key point of the first set of image features to the descriptors of a corresponding feature key point in the previously obtained image. In preferred embodiments, geometric alignment is used to reduce the false matching of feature points.

The vehicle may be imaged while passing a toll booth, at a parking location, in motion on a road or at other suitable location.

Fusing may be performed in accordance with WO/2008/025092 by the same applicant as the present application, the contents of which are incorporated herein by reference.

Identifying a character region (license plate) in an image may be performed in accordance with the teachings of WO/2009/052577 by the same applicant as the present application, the contents of which are incorporated herein by reference.

Verification of identification of an image characteristic, whether license plate, logo, or region of interest, may be performed over multiple image frames in accordance with the teachings of WO/2009/052578 by the same applicant as the present application, the contents of which are incorporated herein by reference.

Toll plaza throughput is a significant factor and detecting a license plate alone may not be possible in high throughput booths with high vehicle speeds. Embodiments of the present invention which rely only on one or more camera images, necessitate no additional infrastructure at the toll booth beyond a camera and the conventional transponder communication system.

Some embodiments of the present invention thus recognise that, in addition to tolling a transponder borne by a vehicle, there is a need to recognise the vehicle itself in order to ensure that the correct tolling rate is being applied to that vehicle.

### BRIEF DESCRIPTION OF THE DRAWINGS

An example of the invention will now be described with reference to the accompanying drawings, in which:

FIG. 1 is an overview schematic of a system in accordance with one embodiment of the present invention;

FIG. 2 illustrates the automated vehicle identification process implemented in the embodiment of FIG. 1;

FIG. 3 illustrates extraction of three sub-images in accordance with the embodiment of FIG. 1;

FIG. 4 illustrates the feature extraction and matching process applied to each sub-image in the embodiment of FIG. 1;

FIGS. 5a and 5b illustrate coarse localisation of key points, and key point qualification;

FIG. 6 illustrates plate matching; and

FIGS. 7a to 7d illustrate box filters suitable for use in one embodiment of the invention.

### DESCRIPTION OF THE PREFERRED EMBODIMENTS

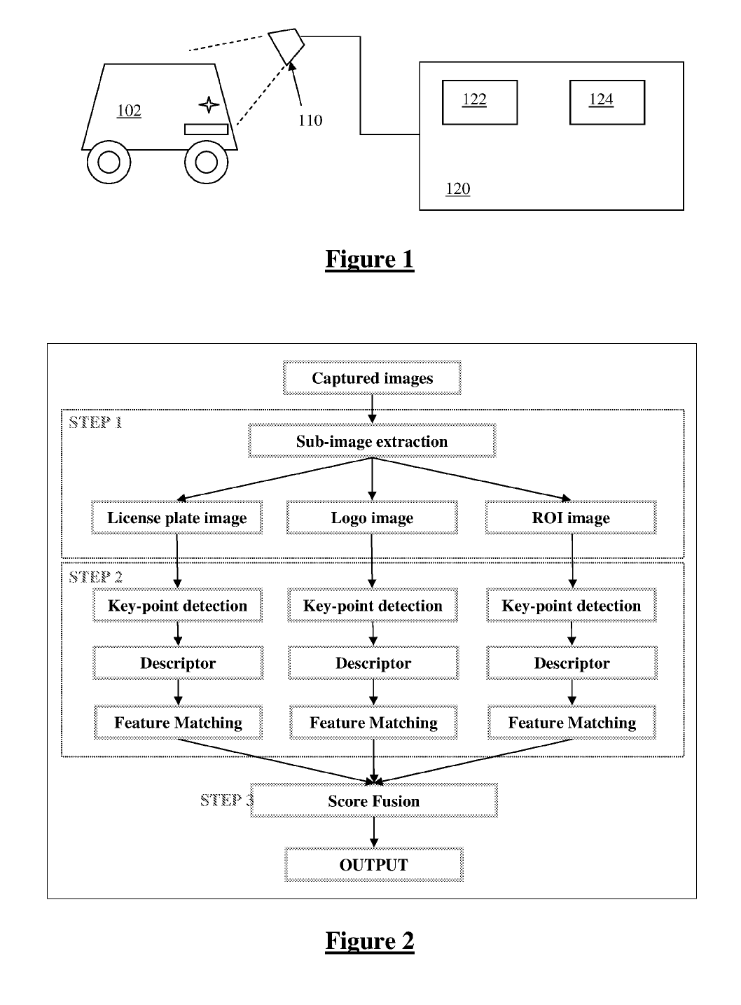

FIG. 1 is an overview schematic of a system in accordance with one embodiment of the present invention. A vehicle 102 is imaged by a camera 110, for example when passing a tolling site. Images from camera 110 are passed to a vehicle matching system 120, which includes an image processor 122 and a database 124 containing obtained vehicles images and/or image feature descriptors.

FIG. 2 illustrates the automated vehicle identification process implemented in the embodiment of FIG. 1. This embodiment uses an image processing technique for identifying distinguishing features of vehicles and thereby identifying and recognizing vehicles based on captured images. This technique utilizes visual characteristics of a vehicle to extract unique image feature descriptors which uniquely identify each imaged vehicle.

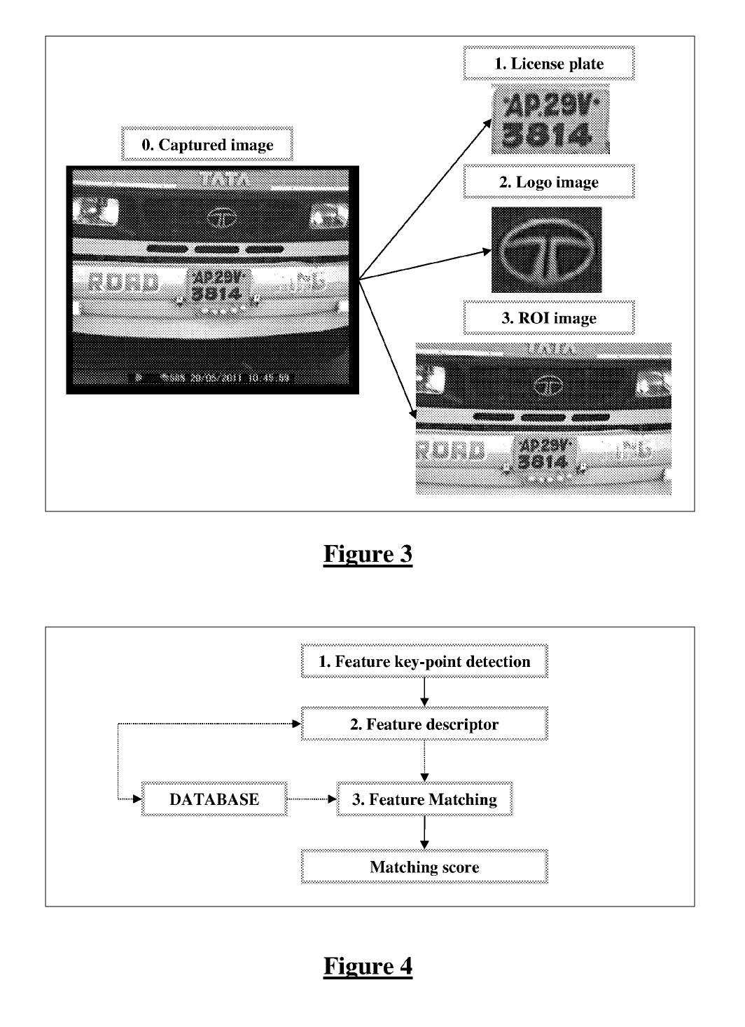

In this patent, unique image feature descriptors for each physical vehicle are extracted from each captured image. This can be considered as a vector of feature values which uniquely represents each vehicle. In the first step, a license plate sub-image, logo sub-image and region of interest (ROI) sub-image are extracted from the captured image (see FIG. 3, and STEP 1 in FIG. 2). Identifying a character region (license plate) in an image may be performed in accordance with the teachings of WO/2009/052577. A region of interest (ROI) sub-image is manually defined from the captured image based on the view of camera. Logo extraction is performed with a Viola-Jones object detection framework based on “Rapid object detection using a boosted cascade of simple features”, Proceedings of the 2001 IEEE Computer Society Conference on Computer Vision and Pattern Recognition, Viola, P., Jones, M., Volume: 1 Page(s): I-511-I-518. Verification of identification of an image characteristic, whether license plate, logo, or region of interest, may be performed over multiple image frames in accordance with the teachings of WO/2009/052578.

In STEP 2 in FIG. 2, feature vectors for each sub-image are calculated in accordance with the algorithm set out in FIG. 4. For license plate image, interesting points on the plate are extracted to provide feature descriptors of the object. These descriptors represent the location and partial identification of the numbers and characters in the plate. The descriptors can then be used to identify a license plate when attempting to match to other extracted license plates. These features should be highly distinctive, easy to extract and tolerant to image translation, scaling, rotation, change in illumination and low bit-rate storage for fast matching.

The method consists of three main steps as illustrated in FIG. 4, namely feature key point detection, feature descriptor derivation, and feature matching.

The feature key-point detection step consists of two steps: coarse localization of feature key-points; and elimination of unstable key-points.

In the first step of coarse localization of feature key-points, interest points are detected in the license plate image. The feature key-points or interest points should have a well-defined position in image space and the local image structure around them should be rich in terms of local information. The present embodiment identifies interest points in the license plate image using the technique described in SURF (Speeded Up Robust Feature (SURF) (Herbert Bay, Andreas Ess, Tinne Tuytelaars, Luc Van Gool “SURF: Speeded Up Robust Features”, Computer Vision and Image Understanding (CVIU), Vol. 110, No. 3, pp. 346-359, 2008)).

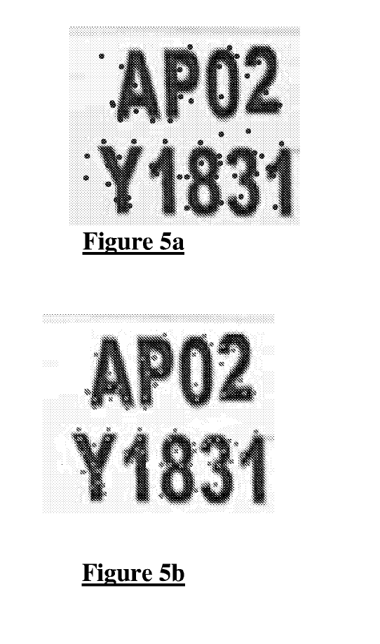

However other embodiments may utilise other techniques to obtain useful performance. For example in such other embodiments a combination of multiple corner detection techniques may be applied to roughly identify the locations of feature key-points. Suitable corner detection techniques include Moravec corner detection (H. Moravec (1980). “Obstacle Avoidance and Navigation in the Real World by a Seeing Robot Rover”. Tech Report CMU-RI-TR-3 Carnegie-Mellon University, Robotics Institute), Harris and Stephens corner detection (C. Harris and M. Stephens (1988). “A combined corner and edge detector”. Proceedings of the 4th Alvey Vision Conference. pp. 147-151), Foerstner corner detection (Foerstner, W; Gulch (1987). “A Fast Operator for Detection and Precose Location of Distinct Points, Corners and Centres of Circular Features”. ISPRS), Wang and Brady corner detection (H. Wang and M. Brady (1995). “Real-time corner detection algorithm for motion estimation”. Image and Vision Computing 13 (9): 695-703), Difference of Gaussian (DoG) (D. Lowe (2004). “Distinctive Image Features from Scale-Invariant Keypoints”. International Journal of Computer Vision 60 (2): 91), Laplacian of Gaussian (Tony Lindeberg (1998). “Feature detection with automatic scale selection”. International Journal of Computer Vision 30 (2): p. 77-116), and Determinant of the Hessian (Tony Lindeberg (1998). “Feature detection with automatic scale selection”. International Journal of Computer Vision 30 (2): p. 77-116). See FIG. 5a for an example of such detection.

However while the Harris detector for example is rotation-invariant, so that even if the image is rotated, it can find the same corners, a problem is that when the image is scaled a corner may not be detected as a corner anymore. Accordingly the present embodiment identifies interest points in the license plate image using the technique described in SURF. D. Lowe, University of British Columbia, proposed a new algorithm, Scale Invariant Feature Transform (SIFT) in his paper, “Distinctive Image Features from Scale-Invariant Keypoints” by using scale-space extrema detection to find key-points. In this approach the Laplacian of Gaussian (LoG) is found for the image with various σ values (σ acts as a scaling parameter). Since the computation of LoG is quite costly, SIFT uses Difference of Gaussians (DoG) as an approximation of LoG. This process is done for different octaves of the image in Gaussian Pyramid. The preferred SURF approach is advantageous because SURF approximates the LoG with box filters. These box filters (shown in FIGS. 7c and 7d) are used to approximate second order Gaussian derivatives and can be evaluated at a very low computational cost using integral images. SURF also relies on determinant of Hessian matrix for both scale and location.

The 9×9 box filters (s=9) in FIG. 7 are approximations of a Gaussian at its lowest scale. One advantage of this approximation is that convolution with such a box filter can be easily calculated with the help of integral images, and moreover can be performed in parallel for different scales.

In the present embodiment, each octave is composed of 4 box filters, which are defined by the number of pixels on their side (denoted by s). The first octave uses filters with 9×9, 15×15, 21×21 and 27×27 pixels (i.e. s={9, 15, 21, 27}, respectively). The second octave uses filters with s={15, 27, 39, 51}, whereas the third octave employs values of s={27, 51, 75, 99}. If the image is sufficiently large, a fourth octave is added, for which s={51, 99, 147, 195}. These octaves partially overlap one another to improve the quality of the interpolated results. To obtain local maxima of the DoH responses, the present embodiment employs a Non-Maximum Suppression (NMS) search method with a 3×3×3 scanning window.

Next, in the step of elimination of unstable key-points, those feature key-points that are not qualified will be eliminated. Specific to license plate image features, feature points will be rejected if they have any one of the following characters: lying on homogeneous regions; lying on or near the edges of license plate; or having low contrast.

The rejection of unstable key-points involves firstly a low-contrast key-point removal. After potential key-points are found, they need to be refined to get more accurate results. A Taylor series expansion of scale space are used to obtain a more accurate location of extrema, and if the intensity at this extrema is less than a threshold value, it is rejected.

Next edge key-point removal is applied. For this step this embodiment uses a 2×2 Hessian matrix (H) to compute the principal curvature similarly as in a Harris corner detector wherein for edges, one eigenvalue is larger than the other. The ratio of these 2 eigenvalues is compared to a threshold (in this embodiment, the threshold having a value of 10) to reject the key-point (if it is greater). The remaining key-points (see FIG. 5b) will then be further processed in the next step.

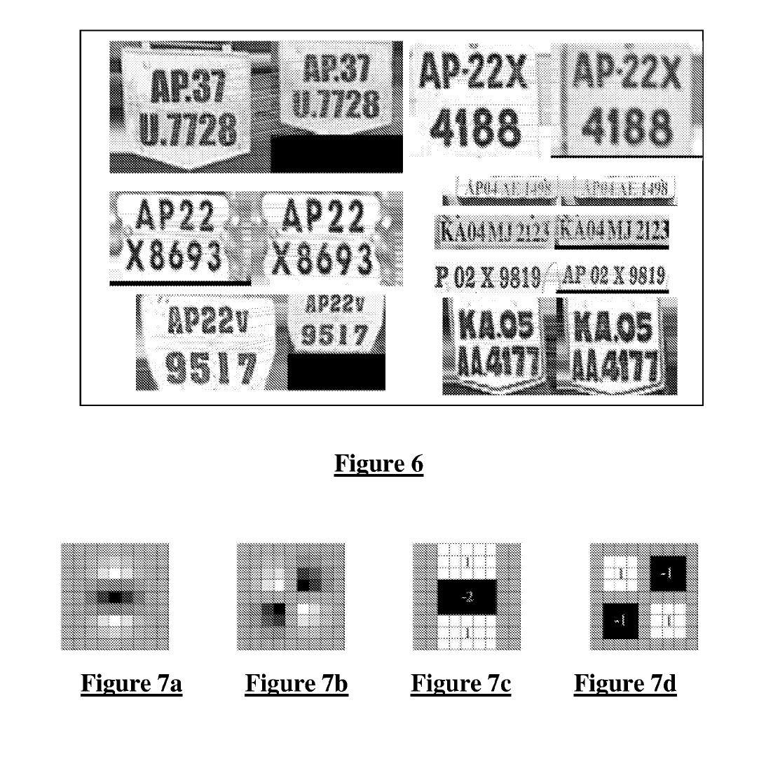

FIG. 6 illustrates some examples of matching plates.

Feature descriptor extraction is then applied to the qualified key points. For each key-point identified in the previous step, the process seeks to extract local feature information around that key-point, and specifically information which is reasonably invariant to illumination changes, to scaling, rotation and minor changes in viewing direction. Four reliable descriptors are proposed to be used as feature descriptors, including: Scale-invariant feature transform (SIFT) (D. Lowe (2004). “Distinctive Image Features from Scale-Invariant Keypoints”. International Journal of Computer Vision 60 (2): 91). Under this descriptor, for each key-point a 16×16 neighbourhood around the key-point is taken, and then divided into 16 sub-blocks of 4×4 size. For each sub-block, an 8 bin orientation histogram is created. So a total of 128 bin values are available. This is represented as a vector to form the first key-point descriptor. A second feature descriptor is extracted using Speeded Up Robust Feature (SURF) (Herbert Bay, Andreas Ess, Tinne Tuytelaars, Luc Van Gool “SURF: Speeded Up Robust Features”, Computer Vision and Image Understanding (CVIU), Vol. 110, No. 3, pp. 346-359, 2008). This feature descriptor uses Wavelet responses in horizontal and vertical direction (whereby the use of integral images advantageously eases computational load and scale tolerance). A neighbourhood of size 20 s×20 s is taken around the key-point where s is the size. It is divided into 4×4 subregions. For each subregion, horizontal and vertical wavelet responses are taken and a vector is formed as v=(Σdₓ, Σd_{y}, Σ|dₓ|, Σ|d_{y}|). SURF feature descriptor is represented as a 64-dimension vector.

Other embodiments may additionally or alternatively use other feature descriptor extraction methods, for example Histogram of Oriented Gradients (HOG) (Navneet Dalal and Bill Triggs “Histograms of Oriented Gradients for Human Detection” In Proceedings of IEEE Conference Computer Vision and Pattern Recognition, San Diego, USA, pages 886-893, June 2005); Local Energy based Shape Histogram (Sarfraz, S., Hellwich, O.: “Head Pose Estimation in Face Recognition across Pose Scenarios”, Proceedings of VISAPP 2008, Int. conference on Computer Vision Theory and Applications, Madeira, Portugal, pp. 235-242, January 2008).

Thus, in this embodiment, for each key-point four feature descriptor vectors are found using the above four techniques respectively. The uniquely identifying information for each vehicle, stored in database 124, then comprises all key-point locations and a set of four local feature descriptors for each key-point.

Feature matching follows. Each type of local feature is matched separately. Distance matching and voting algorithms are used to determine the match of a pair of feature points from two corresponding plates. For distance matching, a distance measure is defined between two feature vectors as the Euclidian distance. For voting, the distance to the best matching feature is compared to the distance to the second best matching feature. If the ratio of closest distance to second closest distance is greater than a predefined threshold (0.85 in this embodiment) then the match is rejected as a false match. A geometric alignment algorithm based on RANSAC (random sample consensus method) is then used to reduce the false matching of feature points (see FIG. 6 for some examples of matching points). Based on the number of matching points, a matching score is calculated which in this embodiment is simply equal to the number of matching points.

As shown in Step 2 of FIG. 2, the same feature extraction and matching algorithm are also applied on the logo sub-image and the ROI sub-image.

In the last STEP 3, matching scores from license plate, logo and ROI images are fused, to decide if there is a match or not. Fusing may be performed in accordance with WO/2008/025092. After obtaining a fused score, a threshold is used to make a decision of whether there is a match, or not. The threshold is set experimentally, based on the receiver operating characteristic (ROC). The ROC is a graphical plot which is created by plotting the fraction of true positives out of the positives (TPR=true positive rate) vs. the fraction of false positives out of the negatives (FPR=false positive rate), at various threshold settings. We choose the threshold with acceptance of TPR and FPR.

To verify robustness and efficiency of the described embodiment, 5000+ captured images of cars were assessed from a car database. 1000 true positives were collected (being different captured images of existing cars in the database) and 1000 true negatives (different captured images of cars not in the database) for query. The true matching rate (TMR): is the ratio of an existing (in database) car being matched. The false matching rate (FMR): is the ratio of a non-existing (in database) car being matched. The true rejecting rate (TRR): is the ratio of a non-existing (in database) car being rejected. The false rejecting rate (FRR): is the ratio of an existing (in database) car being rejected.

The below table summarises the comparison of two approaches:

| | TMR | TRR | FMR | FRR |
|---|---|---|---|---|
| OCR-based | 84.5% | 78.2% | 21.8% | 15.5% |
| Described | 92.1% | 89.2% | 10.8% | 7.9% |
| embodiment | | | | |

The technique of this embodiment can thus be seen to be more robust and efficient than traditional optical character recognition (OCR)-based vehicle matching.

In another embodiment, a two stage approach to vehicle matching may be adopted, wherein conventional optical character recognition (OCR) of license plates may be applied as a first stage. If an OCR match is found in this first stage, the vehicle match is confirmed. If an OCR match is not found in the first stage, the above-described embodiment is applied as a second stage. This two stage approach has been found to further improve the performance to (TMR=95.2%, TRR=92.2%, FMR=7.9% and FRR=4.8%).

In yet another embodiment, we propose a soft-decision classifier based on simple probabilistic classifier, the Bayes classifier. The probability model for the classifier is a conditional model, and can be written as: p(C|F₁, F₂, . . . , Fₙ), where Cis the dependent class variable of matching vehicles, and F₁, F₂, . . . , Fₙ are feature variables. In the present embodiment, the feature variables are the OCR matching score (based on Levenshtein distance) and vehicle DNA matching scores, over single or multiple image frames. Using Bayes' theorem, this embodiment's probability model can be written:

p(C|(F₁,F₂, . . . ,Fₙ)=p(C)(p(F₁|C)p(F₂|C,F₁) . . . p(Fₙ|C,F₁,F₂, . . . ,Fₙ₋₁)

With the assumption that each feature is conditionally independent:

$$p ( C \vert {F}_{1} , {F}_{2} , … , {F}_{n} ) ∝ p ( C ) {\prod }_{i = 1}^{n} p ( {F}_{i} \vert C )$$

In this embodiment the probability functions p(Fᵢ|C) are estimated based on training data. Applying the approach of this embodiment with single frame matching gives the performance of TMR=97.1%, TRR=94.0%, FMR=6.0% and FRR=2.9%. In alternative embodiments where multiple frames can be obtained, this approach can be applied on multiple frames to yield even better results.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of identifying a vehicle, the method comprising:
obtaining from at least one camera at least one image of a vehicle;
using an image processor to derive from the at least one image a first sub-image and a second sub-image distinct from the first sub-image;
extracting from the first sub-image a first set of image features;
extracting from the second sub-image a second set of image features;
matching the first set of image features to corresponding image features derived from a previously obtained image of a vehicle to produce a first matching score;
matching the second set of image features to corresponding image features derived from a previously obtained image of a vehicle to produce a second matching score; and
fusing the first matching score and the second matching score to produce a fused score which indicates whether the at least one image is of the same vehicle as the previously obtained image.

2. The method of claim 1 wherein the first and second sub-images comprise two of: a vehicle license plate sub-image, a vehicle logo sub-image, and a vehicle region of interest sub-image.

3. The method of claim 1 wherein the first and second sub-images, together with a third sub-image, comprise a vehicle license plate sub-image, a vehicle logo sub-image, and a vehicle region of interest sub-image.

4. The method of claim 1 wherein the sub-images comprise wholly distinct sub-areas of the at least one obtained image.

5. The method of claim 1 wherein the region of interest comprises one or more of: a vehicle fender; a vehicle panel and a license plate.

6. The method of claim 1 wherein each set of image features comprises image features which are tolerant to image translation, scaling, and rotation.

7. The method of claim 1 wherein extracting the first and/or second set of image features comprises a first step of coarse localisation of feature key points in the respective sub-image.

8. The method of claim 7 wherein the localised feature key points have a well-defined position in image space and have a local image structure which is rich in local information.

9. The method of claim 7 wherein the feature key points are localised by convolution with a box filter.

10. The method of claim 7 wherein the first and/or second set of image feature points are vetted in order to eliminate unqualified feature points.

11. The method of claim 7 wherein at least one descriptor of each key point is obtained.

12. The method of claim 11 wherein the or each descriptor is at least partly invariant to changes in scaling and rotation.

13. The method of claim 1 wherein matching the first set of image features to corresponding image features derived from a previously obtained image of a vehicle to produce a first matching score comprises applying distance matching and voting techniques in order to determine the match between the descriptors of one feature key point of the first set of image features to the descriptors of a corresponding feature key point in the previously obtained image.

14. The method of claim 1 further comprising assessing geometric alignment of feature points to reduce false matching of feature points.

15. The method of claim 1 wherein the vehicle is imaged while passing a toll booth, at a parking location or in motion on a road.

16. The method of claim 1 further comprising fusion of features identified in a plurality images obtained of the vehicle.

17. A system for identifying a vehicle, the system comprising:
at least one camera for obtaining at least one image of a vehicle; and
an image processor for
deriving from the at least one image a first sub-image and a second sub-image distinct from the first sub-image;
extracting from the first sub-image a first set of image features;
extracting from the second sub-image a second set of image features;
matching the first set of image features to corresponding image features derived from a previously obtained image of a vehicle to produce a first matching score;
matching the second set of image features to corresponding image features derived from a previously obtained image of a vehicle to produce a second matching score; and
fusing the first matching score and the second matching score to produce a fused score which indicates whether the at least one image is of the same vehicle as the previously obtained image.
